(19) United States
(12) Patent Application Publication
(10) Pub. No.: US 2026/0345441 A1
(43) Pub. Date: Nov. 5, 2026

(54) MEDICATION CONTAINER WITH MEDICATION SCHEDULE

(71) Applicant: HONG PENG/, Fremont, CA (US)

(72) Inventor: HONG PENG/, Fremont, CA (US)

(21) Appl. No.: 19/488,591

(22) PCT Filed: Aug. 7, 2024
(86) PCT No.: PCT/US2024/041234

§ 371 Date: Nov. 27, 2025

(51) Int. Cl. A61J 7/04; A61J 1/03; A61J 1/14

(52) U.S. Cl. CPC A61J 7/04; A61J 1/03; A61J 1/1425

(57) ABSTRACT

A medication container includes a medication schedule and a schedule pointer. When the container is opened and then closed completely, the schedule pointer automatically indicates next schedule dosage time.

### CROSS-REFERENCE TO RELATED APPLICATION

This patent application claims priority from U.S. Provisional Patent Application Ser. No. 63/606556, filed on Dec. 5, 2023, which is incorporated by reference herein in its entirety.

### BACKGROUND

Taking medication with scheduled dosage time is a primary requirement for patients. It is a problem that sometimes patients fail to take medication or fail to remember whether they have taken medication as scheduled. Therefore a medication container with a built-in medication schedule indicator is useful for patient medication compliance. There are many devices invented to improve the medication compliance. Some of the devices are standalone reminders and trackers which require patients to intentionally operate the reminders and trackers before or after dispensing medication from medication containers. These devices have a drawback that patients may forget to operate the reminders and trackers even after taking medication. Some of the devices have built-in schedule indicators within medication containers. The built-in schedule indicators are automatically operated when patients open or/and close the container's closure caps. Almost all the built-in schedule indicators in prior art are constructed within the container closure caps. In this invention, a built-in schedule indicator is constructed on a medication container receptacle. This invention is to provide a medication container with a simple and easily-operated medication schedule indicator which can be an assistant tool for users to examine when the last or next scheduled dosage time should be.

SUMMERY The current invention discloses a medication container with a medication schedule and indication mechanism which employs a container receptacle and a container cap to make a schedule pointer to indicate a schedule time when the container is opened and then closed completely. The container can be made with a 7-day medication schedule or a 7-day AM and PM medication schedule.

### BRIEF DESCRIPTION OF THE DRAWINGS

FIG. 1 A perspective view of a medication container with a medication schedule pointer and a stop band with a medication schedule array.

FIG. 2 A perspective view of a medication receptacle assembly including a receptacle, a ratchet band with the schedule pointer and the stop band with the medication schedule array.

FIG. 3 A perspective view of all components of the medication container.

FIG. 4 A bottom view of the container receptacle.

FIG. 5 A top view of the container receptacle.

FIG. 6a A perspective view of a container cap.

FIG. 6b A bottom view of the container cap.

FIG. 6c A view of a cross section of the container cap.

FIG. 7 A schematic diagram of a cross section of the medication container.

FIG. 8 A partial bottom view of engagement of the container receptacle, the ratchet band and the cap without drawing the stop band.

FIG. 9a A schematic diagram of the ratchet band with the schedule pointer.

FIG. 9b A schematic diagram of the ratchet band in a top view.

FIG. 9c A partial schematic diagram of a cross section of the ratchet band on a datum plane cross one side of tooth slits.

FIG. 10a A schematic diagram of engagement of the cam latches, the locking lug, the driving tooth of the cap and the driven tooth of the ratchet band with a pointer when the cap is at a channel position.

FIG. 10b A schematic diagram of engagement of the cam latches, the locking lug, the driving tooth of the cap and the driven tooth of the ratchet band with the pointer when the cap is at a locked position.

FIG. 10c A schematic diagram of engagement of the cam latches, the locking lug, the driving tooth of the cap and the driven tooth of the ratchet band with a pointer when the cap is at an unlocked position.

FIG. 11a A perspective view of a medication container in the second embodiment.

FIG. 11b A perspective view of the medication container cap in the second embodiment.

FIG. 11c A perspective view of the medication container cap in the second embodiment.

FIG. 11d A schematic diagram of a partial cross section of the medication container in the second embodiment.

FIG. 12a A perspective view of a medication container in the third embodiment.

FIG. 12b A perspective view of the medication container cap with C-shape slits in the third embodiment.

FIG. 12c A perspective view of the medication container receptacle with downward ratchet-wheel teeth in the third embodiment.

FIG. 12d A perspective view of a ratchet band with a semicircle pointer, upward pawl teeth and rigid driven teeth.

FIG. 13a A schematic diagram of a non-child-resistant cam latch.

FIG. 13b A schematic diagram of a non-child-resistant cam latch.

### DETAILED DESCRIPTION

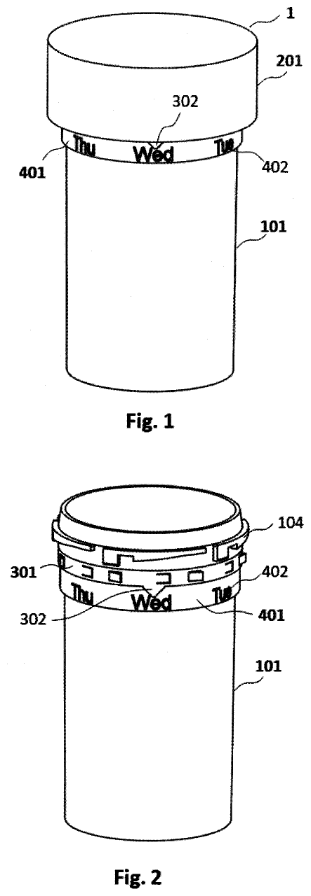

Medication containers disclosed in this presentation include two main parts: a medication receptacle and a closure cap. In the first embodiment, a medication container 1 as shown in FIG. 1 includes a receptacle 101, a cap 201, a schedule pointer 302, a stop band 401 and a schedule array 402. The cap 201 covers an aperture of the receptacle 101. A receptacle assembly as shown in FIG. 2 comprises the receptacle 101, an annular ratchet band 301 with the schedule pointer 302 thereof and the stop band 401 with a schedule array 402. The stop band is attached to outer surface of wall of the receptacle 101. The stop band 401 has a 7-day medication schedule array uniformly displayed on its surface. The schedule array 402 has a symbol array of Mon, Tue, Wed, Thu, Fri, Sat and Sun as shown partially in FIGS. 1 and 2. The 7-day schedule can have various symbol array options such as 1, 2, 3, 4, 5, 6 and 7, Mo, Tu, We, Th, Fr, Sa and Su or I, II, III, IV, V, VI and VII. The 7-day schedule has its symbol elements uniformly spaced on the stop band 401 which has an annular structure. Apart from displaying the schedule array 402, the stop band 401 can support and keep the ratchet band 301 on its right position outside wall of the receptacle 101. The medication schedule array 402 can be printed on the stop band 301 or printed on an adhesive thin strip made of paper or plastics and then attached on the stop band 301.

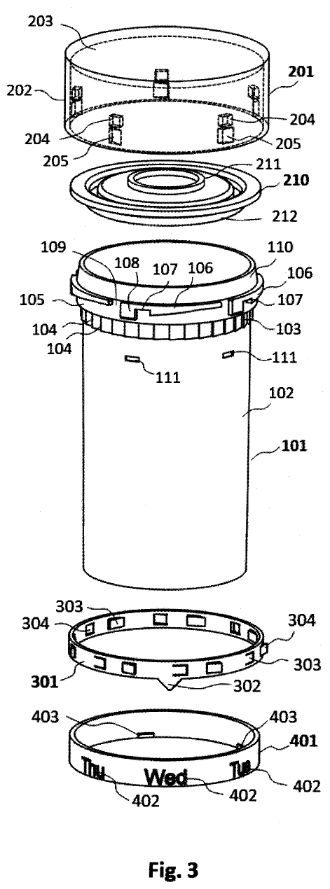

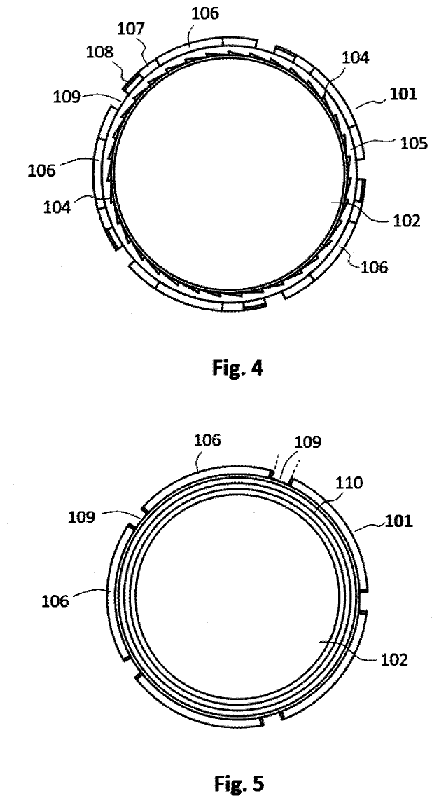

The medication container 1 comprises the receptacle 101, the stop band 401, the ratchet band 301, a sealing plug 210 and a cap 201 as shown in FIG. 3. The receptacle 101 is a cylinder-like and rigid single-piece vial consisting of four portions from its bottom to its top: the first portion is a main receptacle portion 102 with the largest receptacle volume; the second portion is a ratchet-wheel portion 103; the third portion is a cam latch portion 105 and the fourth portion is a receptacle rim portion 110. The fourth portion 110 can be omitted for a receptacle in other embodiments. In the receptacle main portion 102, there is a plurality of snapping notches 111 on outer surface of its wall for fixing the stop band 401. The stop band 401 has a plurality of protruding blocks 403 which can fit into the notches 111. In other embodiments, a medication receptacle without the snapping notches 111 and a stop band without the protruding blocks 403 can be fixed with adhesive materials. In the ratchet-wheel portion 103, there is a plurality of outward-pointing ratchet-wheel teeth 104 around an outer surface of the wall. The ratchet-wheel tooth has a positive hook angle which is angled forward. In the cam latch portion 105, there is a plurality of uniformly spaced cam latches 106. The cam latch 106 includes a locking notch 107 and a stop block 108. Between two adjacent cam latches 106, there is a channel 109 which is defined by an outer space of the circumference of the wall of the receptacle 101 and the two adjacent ends of the cam latches 106 as shown in FIGS. 4 and 5. A plurality of the channels 109 in the cam latch portion 105 can allow driving teeth 205 and locking lugs 204 of the cap 201 as shown in FIG. 3 to align and go through. The receptacle rim 110 with a tapered structure allows the cap 201 to easily slip on and cover the aperture of the receptacle 101.

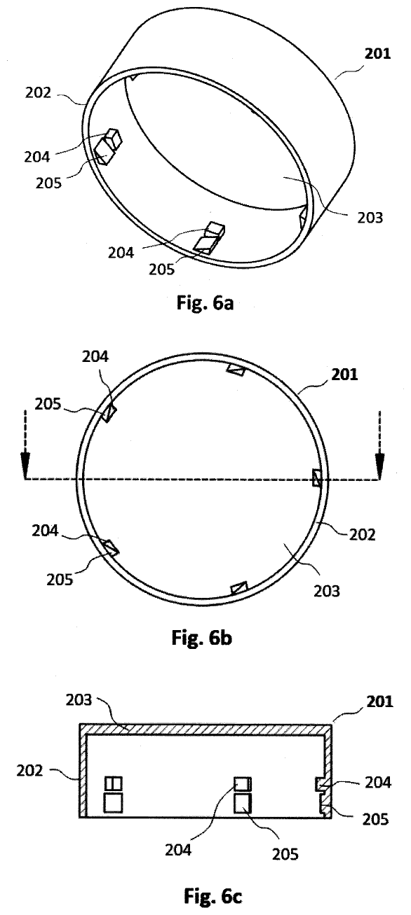

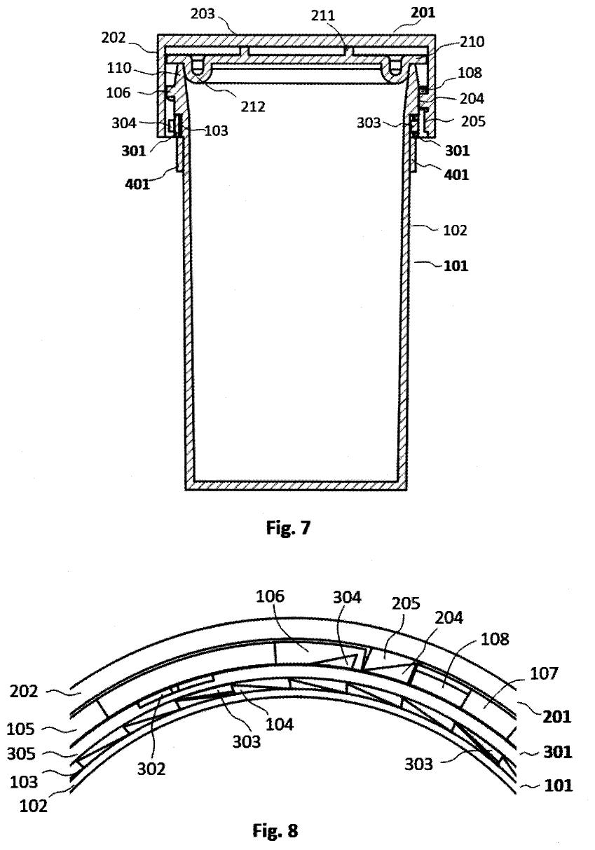

The cap 201 comprises a circular plate 203 and an annular side wall 202 which connects to the plate 203 to form a receptacle with an aperture, a plurality of the locking lugs 204 and the driving teeth 205 on the inner surface of the wall 202 as shown in FIGS. 6a, 6b and 6c. The driving tooth 205 has a triangle shape with a positive hook angle in a bottom view. The locking lug 204 is a rectangular block and its edges can be tapered or rounded. In this embodiment, the locking lug 204 and the driving tooth 205 are separated protrusions. In another option that is easy for manufacture, the locking lug 204 and the driving tooth 205 are combined as one inward protrusion. The sealing plug 210 is made of flexible material such as plastics and is mounted inside of the cap 201 as shown in FIG. 7. A corrugated feature 212 can be pressed against the receptacle rim 110 to seal the receptacle 101. The flexible sealing plug 210 with a protruding feature 211 against the cap plate 203 provides a bias in a direction of detaching the cap 201 to lock the locking lugs 204 to the notch 107. The engagement of the cam latch 106 and the locking lugs 204 is a typical medication container mechanism which may prevent children to access medication in the receptacle 101. To detach the cap 201 and the sealing plug 210 from the receptacle 101, a push down and turn action on the cap 201 is required.

In the first embodiment, the number of a plurality of the fixing notches 111, the cam latches 106, the locking lugs 204 and the driving teeth 205 is five. There are the five cam latches 106 constructed on the receptacle 101 as shown in FIGS. 4 and 5. FIG. 4 shows the receptacle 101 in a bottom view (a view from bottom to top) and FIG. 5 shows the receptacle 101 in a top view (a view from top to bottom). There are thirty five of the fixed ratchet-wheel teeth 104 around an outer circumference of the wall of the ratchet-wheel portion 103. The number of thirty five is a multiplication of the five cam latches 106 and seven days of the schedule array 402. For this invention, the number of schedule elements must be larger than the number of the cam latches. An optimal number for a plurality of ratchet-wheel teeth around an outer circumference of receptacle wall depends on the number of cam latches and the number of medication schedule elements. It should be an integer which can be divided by the number of the cam latches and the number of the schedule array elements. FIG. 8 schematically shows a bottom view of the partial container receptacle 101, the ratchet band 301 and the cap 201. The tooth 104 has a positive hook angle which allows it to be reliable for engaging with the ratchet band 301.

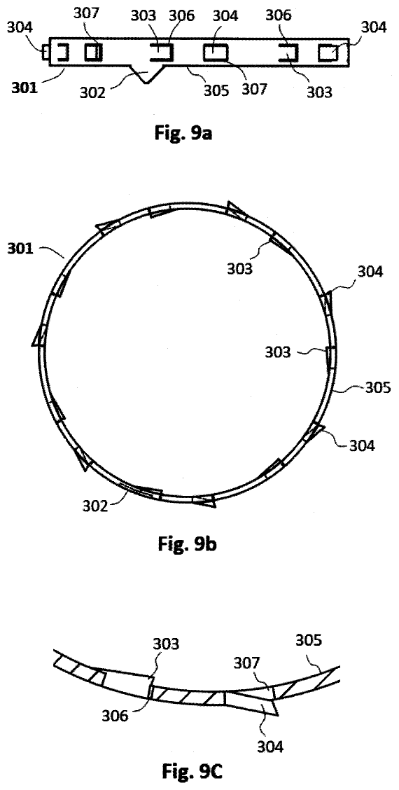

The ratchet band 301 as shown in FIGS. 9a, 9b and 9c comprises an annular ratchet band body 305, seven inward-pointing pawl teeth 303, seven outward-pointing driven teeth 304 and the schedule pointer/tab 302. The seven pawl teeth 303 and seven driven teeth 304 are uniformly constructed around the ratchet band body 305 respectively. A central angle between two adjacent pawl teeth or driven teeth is a result of 360 degree divided by seven. The number of the driven teeth 304 matches the number of the schedule array elements. The number of pawl teeth may not necessarily be seven in other options. The pawl teeth may not necessarily be uniformly constructed around ratchet band body either in other options. The pawl tooth 303 has a positive hook angle to match the positive hook angle of the ratchet wheel tooth 104. The driven tooth 304 has also a positive hook angle matching that of the driving tooth 205 of the cap 201 as shown in FIG. 8. The ratchet band 301 is made of flexible material such as plastics or metal. The pawl teeth 303 and the driven teeth 304 are also flexible. The flexibility of the teeth is achieved by making a C-slit (C-shape slit) 306 surrounding the pawl tooth 303 on three-sides and a C-slit 307 surrounding the driven tooth 304 on three-sides respectively. The both C-slits go through the ratchet band 305. The flexibility depends on not only slit shape and size but also material properties and the thickness of a ratchet band body. The C-slits enable the tip of the tooth 303 or 304 to bend toward the ratchet band body 305 when the gently sloped side of the tooth 303 or 304 is pushed. Because the pawl tooth 303 and the driven tooth 304 can be bent when a radial force is applied to them. However the pawl tooth 303 or the driven tooth 304 can substantially withstand a tangential force when the force is against the steeply sloped side of the tooth. This innovative design of the ratchet band 301 enables it to be rotated in only one direction on the ratchet-wheel portion 103 of the receptacle 101. In the first embodiment, the rotation direction of the ratchet band 301 is clockwise in a top view. In other options, all teeth of a medication container can be designed to rotate a ratchet band in an anticlockwise direction.

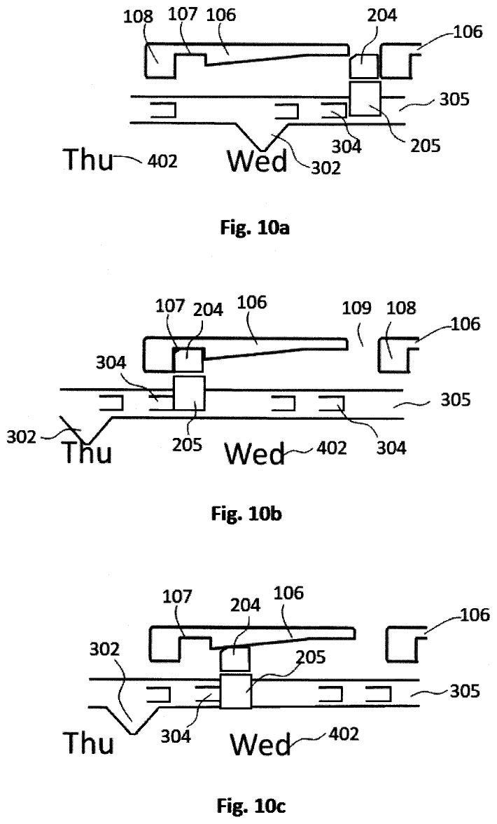

For the medication container 1, there are three defined status: 1) an open status that the receptacle 101 and the cap 201 are separated; 2) a channel status that the locking lugs 204 and the driving teeth 205 are within the channels 109; 3) a locked status that the cap 201 is engaged with the receptacle 101 and the locking lugs 204 are in the locking notch 107. A change of status from the open status to the locked status or vice versa, the cap 201 always goes through the channel status which is schematically shown in FIG. 10a. In the channel status, the cap 201 can be moved up vertically and disengaged with the receptacle 101, or can be rotated or pushed down and rotated. The rotation allows the driving tooth 205 to engage with the most adjacent driven tooth 304 and then rotate the ratchet band body 305 and the pointer 302. From the channel status to the locked status as shown in FIG. 10b, the driven tooth 304 rotates an angle of 360 degree divided by seven and the pointer 302 moves from one schedule array element to another one. However the container 1 can be in an undefined status when a user rotates the cap 201 and stops short of locking the cap as shown in FIG. 10c. The pointer 302 doesn't indicate rightly on a schedule array element. Fortunately, the way of displaying the medication schedule array 402 with the pointer 302 in an open circular space allows more error tolerance than a window indicator on a cap in some prior arts. Users can easily judge when the last or next scheduled dosage time should be in the medication schedule array 402 based on where the pointer 302 indicates. Therefore this invention is to provide an assistant tool to help users to judge when was the last dosage time they took medication in case that they don't remember if they have taken medicine as scheduled. Generally, the pointer 302 can be set up for the next dosage time or the last dosage time that medication was taken. If users get used to operate the medication container 1 always from the status 1 to 2 to 3, or 3 to 2 to 1 without any reverse rotation during an open or close process, the pointer 302 should always indicate rightly on a schedule array element. When the container 1 is in an undefined status, it is easy for a user to remove the cap 201 and rotate the ratchet band 301 by fingers and recalibrate the location of pointer 302 on the medication schedule array 402.

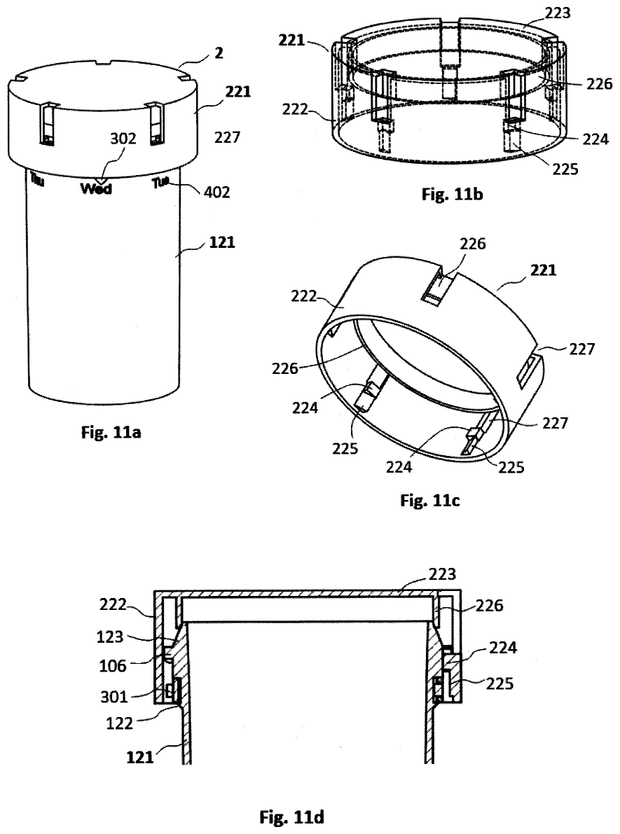

In the second embodiment, a medication container 2 is shown in FIGS. 11a, 11b, 11c and 11d. The cam latches 106 and the ratchet band 301 remain the same as the first embodiment. But the sealing plug 210 and the stop band 401 in the first embodiment are not utilized in this embodiment. In the second embodiment, the schedule array 402 can be directly printed on outer surface of wall of a medication receptacle 121 or printed on a tape sticker and then adhered on outer surface of the wall of the medication receptacle 121. A top rim 123 of the receptacle 121 is tapered on outer circumference of the rim 123. Instead of a stop band, there is a protruding rib 122 on outer surface of the wall of the receptacle 121 to restrain the ratchet band 301. The same ratchet-wheel portion 103 is still utilized in the receptacle 121. A cap 221 has an annular and flexible inner wall 226 with a top plate 223 to cover and seal the receptacle 121. An outer side wall 222 has a plurality of opening slots 227 above a plurality of locking lugs 224. The opening slots 227 make a manufacture process of the cap 221 simple. The locking lugs 224 and driving teeth 225 are protrusions on the inner surface of the outer side wall 222. In this embodiment, the lug 224 and the driving tooth 225 are combined as one protruding block. The inner wall 226 with a top plate 223 that connects the outer side wall 222 can provide bias in a direction of detaching the cap 221 to keep the locking lugs 224 locked in the cam latches and the aperture of the receptacle 121 sealed.

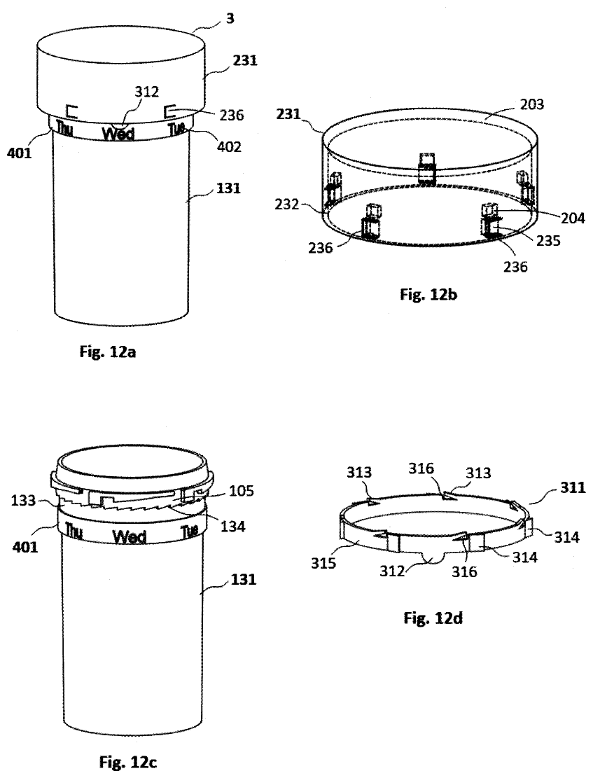

In the third embodiment, a container 3 is another variant of the container 1 with variation on the ratchet band 301, the receptacle 101 and the cap 201 as shown in FIGS. 12a, 12b, 12c and 12d. A new receptacle 131 as shown in FIG. 12 c inherits all features from the receptacle 101 except the ratchet-wheel portion 103. In a new ratchet-wheel portion 133, a plurality of ratchet-wheel teeth 134 with their tips pointing toward the bottom direction of the receptacle are constructed under a cam latch portion 105. A new ratchet band 311 as shown in FIG. 12d comprises an annular ratchet band body 315, seven upward pawl teeth 313, seven driven teeth 314 and a schedule pointer/tab 312. An opening slot 316 enables the pawl tooth 323 to be bent downward. The driven tooth 314 is rigid and has a positive hook angle. The pointer 312 is a semi-circle tab which is more resistant to unwanted rotation of the ratchet band 311 by pushing/pulling the pointer tab when the container 3 is in a locked status. To adapt the rigid driven teeth 314, a plurality of flexible driving teeth 235 are constructed on a cap 231 as shown in FIG. 12b. The cap 231 is identical to the cap 201 in all features except the driving teeth 235. The driving tooth 235 is a driving tooth 205 with a C-slit 236 constructed surrounding it on three sides. The C-slit 236 cuts through the cap side wall 232. The C-slit 236 enables the tip of the driving tooth 235 to bend inward or outward.

In above embodiments, all of the medication containers have a 7-day medication schedule. For a schedule with fourteen schedule array elements such as Mon am, Mon pm, Tue am, Tue pm, Wed am, Wed pm, Thu am, Thu pm, Fri am, Fri pm, Sat am, Sat pm, Sun am and Sun pm, an angle for each turn of a schedule pointer becomes smaller. There are more choices for the number of cam latches on a receptacle wall. It can be five, six, seven or more. In the fourth embodiment, a medication container 4 has a receptacle with the fourteen symbol array elements, six cam latches and forty two ratchet-wheel teeth. The ratchet band of the container 4 has fourteen driven teeth and seven pawl teeth. The cap of the container 4 has six locking lugs and six driving teeth. The container 4 can be a variant of container 1, 2 or 3.

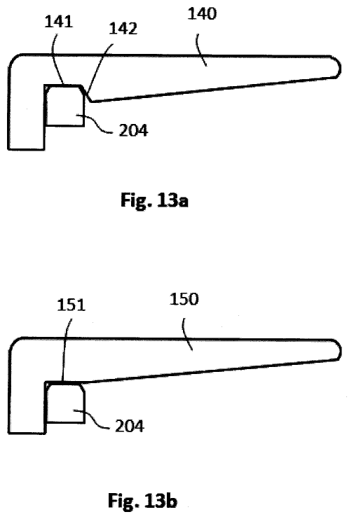

In above embodiments, cam latch 106 has child-resistant design so that the caps can only be unlocked from the receptacles by an action of pushing down and rotation. However cam latch in this invention can be non-child-resistant so that caps can be unlocked by an action of rotation without pushing down. In FIGS. 12a and 12b, two variants of the cam latch 106 are non-child-resistant. Cam latch 140 has a receiving notch 141 with a slope face 142 instead of a vertical face of the cam latch 106. The slope face 142 allows the locking lug 204 to slide off the receiving notch 141 by a rotation force without pushing down caps. A cam latch 150 as shown in FIG. 13b doesn't even have a receiving notch. Instead of a receiving notch, the cam latch 150 has a flat face 151.

While the invention has been described in conjunction with the preferred embodiments, features and methods, it should be noted that many alternatives, novel features, novel combination, modifications and variations are apparent to those skilled in the art. Accordingly, the preferred embodiments and description in the invention set forth above are intended to be illustrative and not limiting. Various changes may be made without departing from the spirit and scope of the disclosure.

What is claimed is

1. A container with a schedule array comprising:
a cap having a plurality of locking lugs and a plurality of driving teeth on inner surface of its side wall;
a receptacle assembly including
a receptacle having a plurality of cam latches for engaging said locking lugs, and having a plurality of ratchet-wheel teeth on outer surface of its wall,
a schedule array displayed on outer surface of wall of said receptacle or on a stop bend attaching to outer surface of the wall of said receptacle,
a ratchet band having a plurality of pawl teeth for engaging said ratchet-wheel teeth, and having a plurality of driven teeth for engaging said driving teeth, and having a pointer for indicating said schedule array;
means for biasing said cap in a direction of detaching said cap.

2. The container of claim 1, wherein said cam latch is a cam latch with a child-resistant locking notch thereof.

3. The container of claim 1, wherein said cam latch is a non-child resistant cam latch.

4. The container of claim 1, wherein said ratchet-wheel tooth is an outward protrusion on outer surface of wall of said receptacle with a positive hook angle.

5. The container of claim 1, wherein said ratchet-wheel tooth has a tooth tip toward a bottom direction of said receptacle.

6. The container of claim 1, wherein said pawl tooth has a C-slit surrounding it on said ratchet band.

7. The container of claim 1, wherein said driven tooth has a C-slit surrounding it on said ratchet band.

8. The container of claim 1, wherein said driving tooth has a C-slit surrounding it on said cap.

9. The container of claim 1, wherein the number of said plurality of cam latches is five.

10. The container of claim 1, wherein the number of said a plurality of ratchet teeth is an integer number which can be evenly divided by the number of said cam latches and the number of said schedule array elements.

11. A container with a schedule array comprising:
a cap having a plurality of locking lugs and a plurality of driving teeth on inner surface of its side wall;
a receptacle assembly including
a receptacle having a plurality of cam latches for engaging said locking lugs, and having a plurality of ratchet-wheel teeth on outer surface of its wall,
a schedule array displayed on outer surface of wall of said receptacle or on a stop bend attaching to outer surface of the wall of said receptacle,
a ratchet band having a plurality of pawl teeth for engaging said ratchet-wheel teeth, and having a plurality of driven teeth for engaging said driving teeth, and having a pointer for indicating said schedule array;
a sealing and biasing plug that is mounted in said cap.
